(19) United States
(12) Patent Application Publication
(10) Pub. No.: US 2017/0019031 A1
(43) Pub. Date: Jan. 19, 2017

(54) CONTROL OF POWER CONVERTERS

(71) Applicant: FINsix Corporation, Menlo Park, CA (US)

(72) Inventors: Anthony Sagneri, Palo Alto, CA (US); Victor Sinow, Oakland, CA (US); Ranko Sredojevic, Berkeley, CA (US); Milovan Kovacevic, Redwood City, CA (US)

(21) Appl. No.: 15/270,209

(22) Filed: Sep. 20, 2016

Related U.S. Application Data
(63) Continuation of application No. PCT/US2016/022571, filed on Mar. 16, 2016.
(60) Provisional application No. 62/133,567, filed on Mar. 16, 2015.

(51) Int. Cl. H02M 3/335; H02M 1/44; H02M 1/42

(52) U.S. Cl. CPC H02M 3/33507; H02M 1/4241; H02M 1/44

(57) ABSTRACT

Control techniques and circuits for resonant power converters and other power converters are described. Control of power converters based on more than one control parameter can provide improved efficiency over a wide operating range. A resonant power converter may have its switching frequency controlled within a narrow band to improve efficiency.

### CROSS-REFERENCE TO RELATED APPLICATIONS

This application is a continuation of International PCT Application, PCT/US2016/022571, titled “CONTROL OF RESONANT POWER CONVERTERS,” filed Mar. 16, 2016, which claims priority to U.S. provisional application Ser. No. 62/133,567, titled “RESONANT POWER CONVERTERS AND STACKED POWER CONVERTERS AND ASSOCIATED CONTROL TECHNIQUES,” filed Mar. 16, 2015, each of which is incorporated herein by reference in its entirety.

### DISCUSSION OF RELATED ART

Power electronics refers to electronics for the processing of electric power. A power converter is a power electronics circuit that converts power from one form to another. Common examples of power converters include AC-DC converters, DC-AC converters, DC-DC converters and AC-AC converters. Power converters may change AC power to DC power, DC power to AC power, and/or may process power to produce changes in the magnitude of voltage and/or current, for example.

### SUMMARY

Some embodiments relate to a power module. The power module includes a resonant power converter having a switch network having one or more switches and a resonant tank circuit. The power module also includes a controller configured to control the resonant power converter. The controller is configured to switch the one or more switches of the switch network at a switching frequency. The controller is configured to sub-modulate the resonant power converter on and off at a second frequency lower than the switching frequency with a sub-modulation duty ratio. The controller is configured to control the resonant power converter by varying the switching frequency and the sub-modulation duty ratio.

Some embodiments relate to a controller for a resonant power converter having a switch network having one or more switches and a resonant tank circuit. The controller includes circuitry configured to control the resonant power converter to switch the one or more switches of the switch network at a switching frequency, to sub-modulate the resonant power converter on and off with a sub-modulation duty ratio at a second frequency lower than the switching frequency, and to control the resonant power converter by varying the switching frequency and the sub-modulation duty ratio

Some embodiments relate to a method of controlling a resonant power converter having a switch network having one or more switches and a resonant tank circuit. The method includes switching the one or more switches of the switch network at a switching frequency, sub-modulating the resonant power converter on and off with a sub-modulation duty ratio at a second frequency lower than the first frequency, and varying the switching frequency and the sub-modulation duty ratio of the resonant power converter.

Some embodiments relate to a power module that includes a power converter having one or more switches and a controller configured to control the power converter. The controller is configured to switch the one or more switches of the switch network at a switching frequency, to sub-modulate the power converter on and off with a sub-modulation duty ratio at a second frequency lower than the switching frequency, and control the power converter by varying the sub-modulation duty ratio as a first control parameter and by varying a second control parameter of the power converter.

Some embodiments relate to a controller for a power converter, the power converter having one or more switches. The controller includes circuitry configured to switch the one or more switches at a switching frequency, to sub-modulate the power converter on and off with a sub-modulation duty ratio at a second frequency lower than the switching frequency, and to control the power converter by varying the modulation duty ratio as a first control parameter and by varying a second control parameter of the power converter.

Some embodiments relate to a method of controlling a power converter having one or more switches. The method includes switching the one or more switches at a first frequency; sub-modulating the power converter on and off with a sub-modulation duty ratio at a second frequency lower than the switching frequency; and controlling the power converter by varying the sub-modulation duty ratio as a first control parameter and by varying a second control parameter of the power converter.

Some embodiments relate to a method of soft-starting a resonant power converter. The method includes detecting connection of the resonant power converter to an AC line voltage; in response to detecting the connection, setting a switching frequency of the resonant power converter to a first frequency; and reducing the switching frequency to a second frequency lower than the first frequency.

Some embodiments relate to a power module configured to be connected to an AC line voltage. The power module includes a resonant power converter; and a switched capacitor converter having its operating mode configured based upon the AC line voltage.

Some embodiments relate to a method of operating a power module having a switched capacitor converter. The method includes detecting an AC line voltage provided to the power module; and controlling the switched capacitor converter to be in different operating modes based on the AC line voltage.

Some embodiments relate to at least one non-transitory computer readable storage medium having stored thereon instructions, which, when executed by a processor, perform a method as described herein.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques described herein.

FIG. 1 shows the efficiency of a resonant power converter versus switching frequency.

FIG. 2 shows a timing diagram illustrating sub-modulation.

FIGS. 3A-3I show block diagrams of resonant power converters controlled by a variety of control techniques using switching frequency modulation and sub-modulation.

FIG. 4 shows a circuit diagram of an LLC converter, according to some embodiments.

FIG. 5 illustrates hysteretic control of the output of a resonant power converter.

FIG. 6 shows examples of curves mapping input voltage to switching frequency for different output power levels.

FIGS. 7A-7D illustrate block diagrams and waveforms of a buck converter controlled with duty ratio D modulation and sub-modulation duty ratio M.

FIG. 8 shows an example of a switched capacitor converter, according to some embodiments.

FIGS. 9A and 9B show power adapters or power modules having a switched capacitor converter preceding or following a resonant power converter.

FIG. 10 shows an illustrative computing device.

### DETAILED DESCRIPTION

Due to conservation of energy, the power at the output port of a power converter is less than or equal to the power at the input port. Real-world power converters have losses, including but not limited to conduction losses, switching losses, losses in magnetic components, etc., which convert a portion of the input power into heat. The efficiency of a power converter is the ratio of its output power to its input power. Due to power losses, the efficiency of a real power converter is less than 100%. It would be desirable to improve the efficiency of power converters to reduce the amount of power lost as heat, which also has the benefit of limiting the rise in temperature of the power converter. Power converters that are less efficient may need to be designed to dissipate heat for reasons such as improving the lifetime of components and staying within regulatory limits for consumer devices, by way of example. Active and/or passive cooling may need to be used to keep the temperature of a power converter within acceptable limits. Improving the efficiency of a power converter would reduce the need for thermal management.

There is also a desire to reduce the size of power converters for many applications. For example, in consumer applications, it would be desirable to reduce the size of power converters to reduce the size of power adapters or power modules for consumer electronic devices, particularly those having significant power requirements. Although small power adapters are available in the marketplace for charging small consumer electronic devices such as cellular telephones, such devices have limited output power.

The size of passive components within a switch-mode power supply (SMPS) can be reduced by increasing the switching frequency. Increasing the switching frequency increases the rate at which the switches of the power converter are turned on and off, which increases switching power loss due to the energy dissipated each time the switches of the power converter are turned on or off.

In order to achieve the highest possible efficiency in a SMPS, resonant power converters of various topologies are often used. These topologies allow for improved efficiency primarily through the reduction of switching losses in the power semiconductors. Switching loss arises from two sources—overlap loss, occurring when the voltage and current at the port of a power semiconductor are simultaneously non-zero, and capacitive discharge loss, arising when energy stored in transistor or diode parasitic capacitances are dissipated as a result of commutating the device.

Overlap loss is reduced or mitigated by using resonant circuits to achieve nearly orthogonal voltage and current at power semiconductor device ports during commutation. This is typically accomplished by arranging the SMPS network with complementary reactance, which allows the state of the power semiconductor parasitic capacitances to be modified before commutation. For instance, in converters that utilize zero-voltage switching (ZVS) this allows the device voltage to ring to near-zero before the channel begins to conduct. Additionally, since the device voltage is zero before turn-on, capacitive-discharge losses are also mitigated. In zero-current switching (ZCS) the current is brought to zero before the device is commutated. While this mitigates overlap loss, it may not address capacitive discharge loss.

While resonant power converters can dramatically reduce frequency-dependent switching losses, this is accomplished at the expense of circulating currents that arise from the resonant action. These circulating currents cause loss in the form of increased (root-mean-square) conduction currents in the power devices and dissipation in the various reactive elements themselves as energy is alternately cycled among them. The net result is that many resonant converters are only efficient in a relatively narrow operating regime as compared to traditional hard-switching converter topologies.

One way operating regime restrictions manifest in resonant converters occurs when frequency modulation is used to affect control. In this approach, the resonant power converter is designed to deliver maximum power near some frequency, and power is reduced as the converter frequency is moved elsewhere. Such converters include the series resonant converter, the parallel resonant converter, and the LLC, among a host of others. When the converter is operating near resonance and delivering maximum power, much of the current circulating in the network carries real power from the source to the load. However, as the frequency is slewed away from the maximum power point, (e.g., to adjust to a change in load), the circulating currents arising from commutation of the switches begin to dominate. In the extreme case, almost all the energy circulating in the network can be due to commutation of the switches. Since little or no power is delivered to the load, this operating point is very inefficient.

Reduced efficiency arises if input voltage or output voltage changes need to be accommodated, as this requires a change in switching frequency to maintain the desired output. For instance, in an LLC converter operated on the inductive side of its transfer function, output voltage can be regulated in the face of load by slewing the switching frequency. If the load increases, the frequency is lowered to keep the output voltage from drooping. If the load decreases, the frequency is raised to prevent the output voltage from rising.

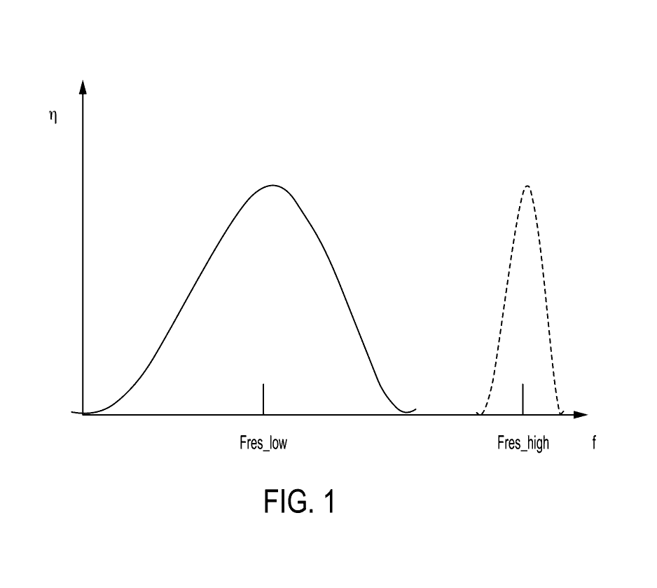

The efficiency of a resonant power converter changes significantly when the switching frequency is changed. As illustrated in FIG. 1, resonant power converters are most efficient when operated with a switching frequency within a range of frequencies near the resonant frequency. FIG. 1 shows the efficiency η of a resonant power converter versus switching frequency. The solid curve shows the efficiency for a power converter having a relatively low resonant frequency Fres_low, and the dashed curve shows the efficiency for a power converter having a relatively high resonant frequency Fres_high. As illustrated in FIG. 1, the higher the resonant frequency is the more the range of switching frequencies for which the converter can operate efficiently shrinks. This is an obstacle for producing a high-frequency resonant power converter that is capable of operating efficiently across a wide range of inputs and/or outputs. In a conventional resonant converter controlled by switching frequency modulation, the switching frequency may need to be changed across a wide range to control the power converter across a wide range of inputs or outputs. If a resonant power converter is operated near extrema of its input and/or output range the efficiency is reduced significantly. Although a high-frequency resonant power converter may be designed to operate efficiently in a narrow range of switching frequencies, it will become less efficient as the input and/or output varies, due to the change in switching frequency needed to accommodate these inputs and/or outputs. To improve efficiency, it would be desirable to operate a resonant power converter over a narrower range of switching frequencies at which the converter is most efficient.

The extrema of the frequency range are determined by the desired load range and the design of the resonant tank circuit. As load range is increased, the gap between peak efficiency and minimum efficiency across the load range typically increases, as well. This undesirable characteristic arises partially because increased load range is typically realized by increased frequency range. The challenge compounds if the input voltage is allowed to vary. At a given frequency the output power will rise with input voltage, thus introducing input voltage variation which further increases the required frequency range, and the result is usually undesirably low efficiency over some area of the operating regime.

The inventors have recognized and appreciated that these challenges can be overcome by introducing a second control parameter that provides a second degree of freedom to control the power converter. In a resonant power converter, the second control parameter can be used to compress the switching frequency range over a given operating regime of inputs and outputs, resulting in a smaller spread between peak and minimum efficiency. For instance, by introducing on-off modulation, the average output power delivered to the load and the instantaneous power through the power converter can be different. This allows flexibility in choosing the operating point of the converter, which can yield any number of benefits (e.g. increased efficiency, lower device stresses, reduced electromagnetic emissions).

In some embodiments, a resonant power converter may be sub-modulated at a sub-modulation frequency lower than the switching frequency of the resonant power converter. To sub-modulate a power converter, the power converter is switched on an off at the sub-modulation frequency. As an example, if the resonant power converter has a switching frequency in the MHz range, the resonant converter may be turned on and off at a frequency in the kHz range. However, this is merely by way of example, and any suitable sub-modulation frequency may be selected.

By way of example, consider an LLC converter to be operated over a 10:1 load range and a 3:1 input voltage range. If switching frequency is the only control handle, the difference between maximum and minimum switching frequency would be quite large. The resulting converter efficiency may be unacceptably low at some points in the desired operating regime. If on-off modulation is introduced to regulate the output power, then frequency modulation may be employed to accommodate only the input voltage range. One way to accomplish this would be to select the operating frequency as a function of input voltage such that the instantaneous power of the LLC power stage is held approximately constant. Then, as the load demands more or less power, the sub-modulation duty ratio is varied while the frequency remains constant for any given input voltage.

The resulting compression of frequency range allows the efficiency spread to be reduced over the operating regime of inputs and outputs. In the case of a constantly varying input, such as the rectified AC utility line voltage, this technique produces an overall increase in converter efficiency over the desired load range.

It should be recognized that the roles of the two control handles (switching frequency, f, and sub-modulation duty ratio, M) may be interchanged, or otherwise combined in any fashion to achieve the desired goal, whether efficiency, reduced switch stress, reduced EMI, or a combination of these. For example, the on-off modulation may be used to accommodate the input line variation and frequency modulation may be used to accommodate load changes. The frequency to input voltage map vary depending on load.

Controlling a second degree of freedom of the power converter is particularly valuable if the desire is to increase switching frequency dramatically, as illustrated by FIG. 1. As frequency increases, the resonant circulating currents increase accordingly. This makes the inefficiency associated with moving away from the optimal operating point manifest more rapidly because the resonant commutation currents make up a larger portion of the total current in the converter and they do not necessarily scale with load.

In conventional AC/DC power modules that are designed to convert power from the mains into a DC voltage, power factor correction circuitry is provided on the front-end of the converter. Power factor correction circuitry is required on the front end in some applications above a certain wattage to preserve the power quality on the mains line. Such power factor correction circuitry includes one or more passive components, such as a capacitor, that has the effect of stabilizing the input voltage to the power converter. As a result, the power converter does not need to accommodate as large of an input range, and accordingly may be designed to operate more efficiently.

However, in some applications power factor correction circuitry may be omitted where it is not required. For example, power factor correction circuitry may not be required for switch mode power supplies having wattages below a certain value. A cost savings can be achieved by omitting the power factor correction circuitry. However, doing so may make the input voltage to the converter less stable, and it may need to operate over a wider range of inputs. Accordingly, the technique of introducing a second degree of freedom may be particularly valuable in applications where power factor correction circuitry is omitted, as it can allow accommodating the wider range of input voltages produced by omitting power factor correction circuitry.

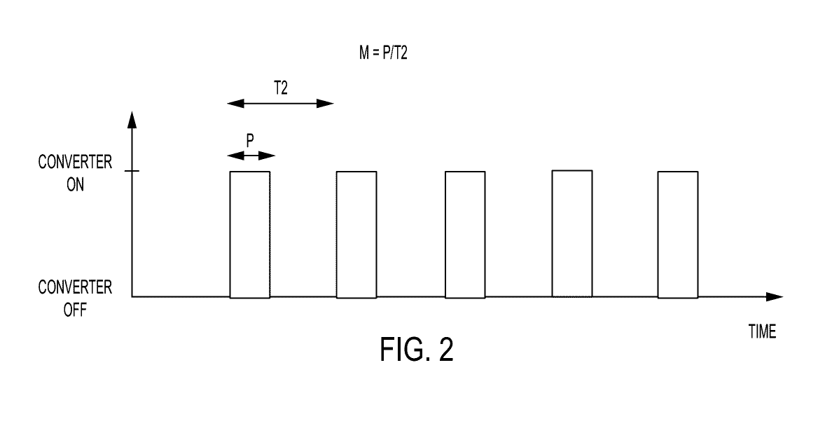

FIG. 2 shows a timing diagram illustrating sub-modulation. The power converter is turned on for a time P and then turned off for a period of time. In this example, the sub-modulation is periodic with a sub-modulation period T2 and sub-modulation frequency of 1/T2. The sub-modulation duty ratio M is the fraction of the sub-modulation period for which the power converter is turned on, and is expressed by M=P/T2. Increasing the sub-modulation duty ratio increases the output of the power converter for a constant input. Conversely, decreasing the sub-modulation duty ratio decreases the output of the power converter for a constant input. Varying the sub-modulation duty ratio provides an additional degree of freedom of control that can accommodate a wide range of inputs and outputs while maintaining switching frequency within a narrow range. In some embodiments, the sub-modulation frequency may be between 0.01% and 10% of the switching frequency. In some embodiments, the sub-modulation frequency may be between 20 kHz and 300 MHz.

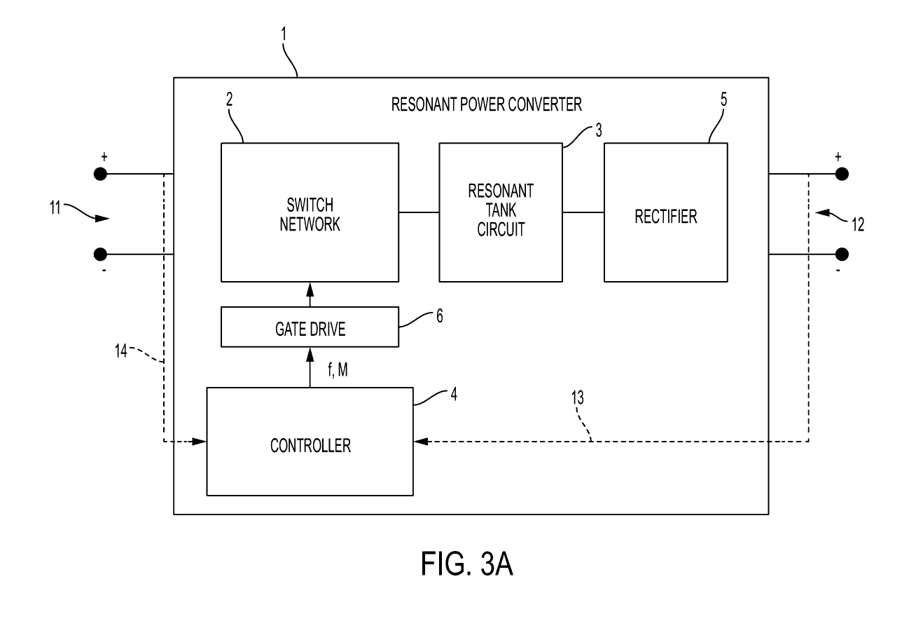

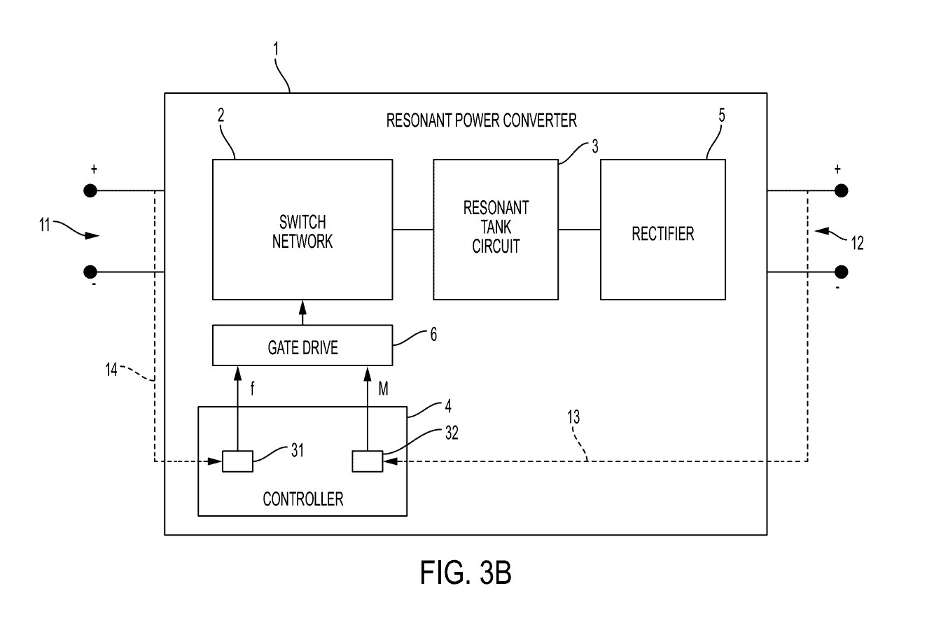

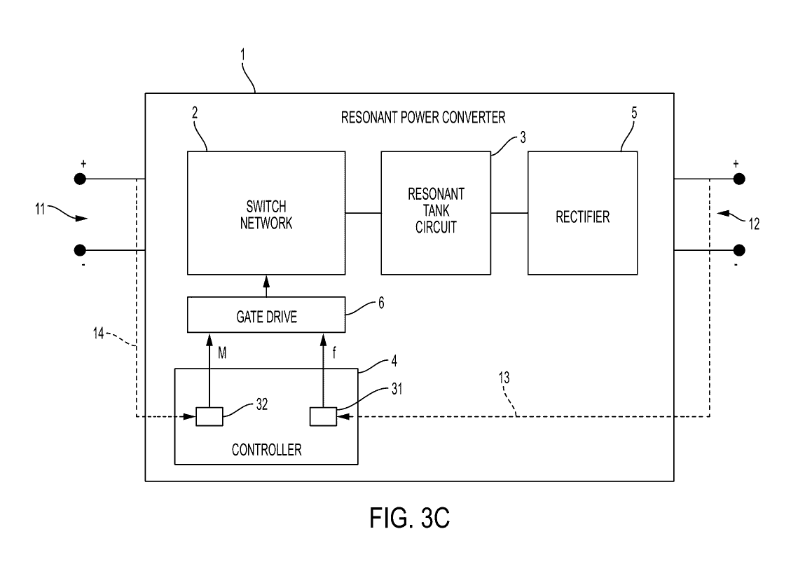

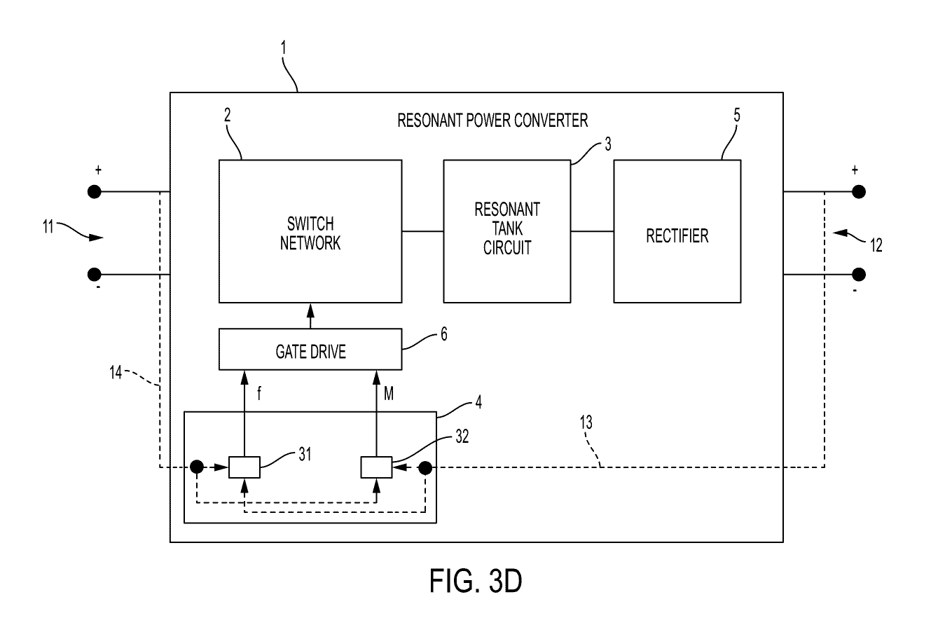

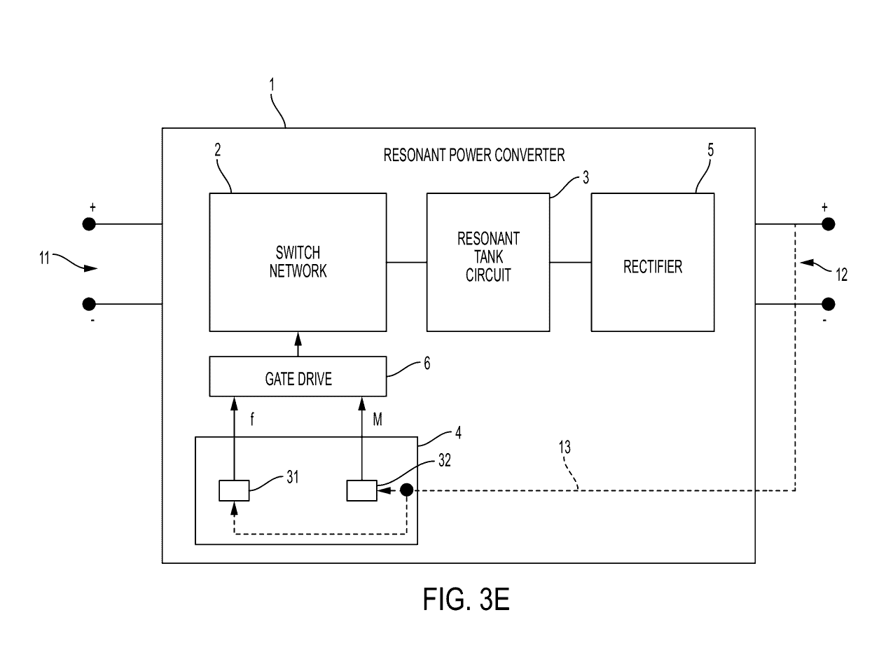

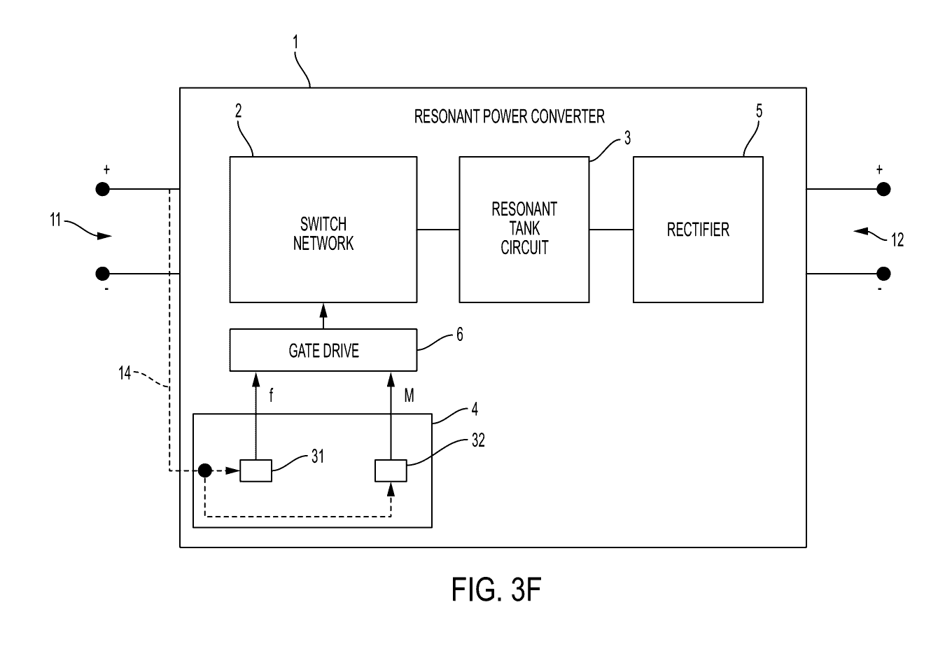

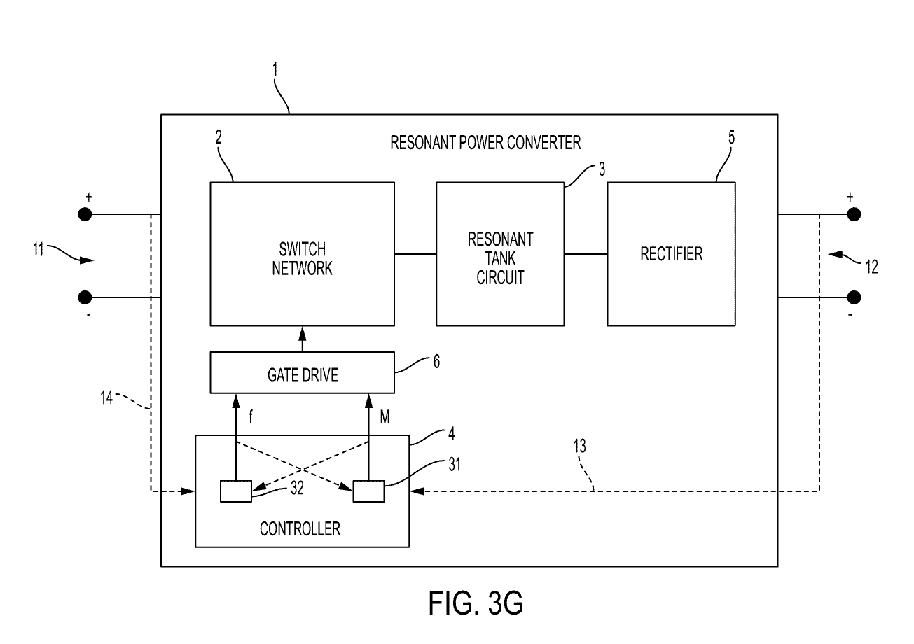

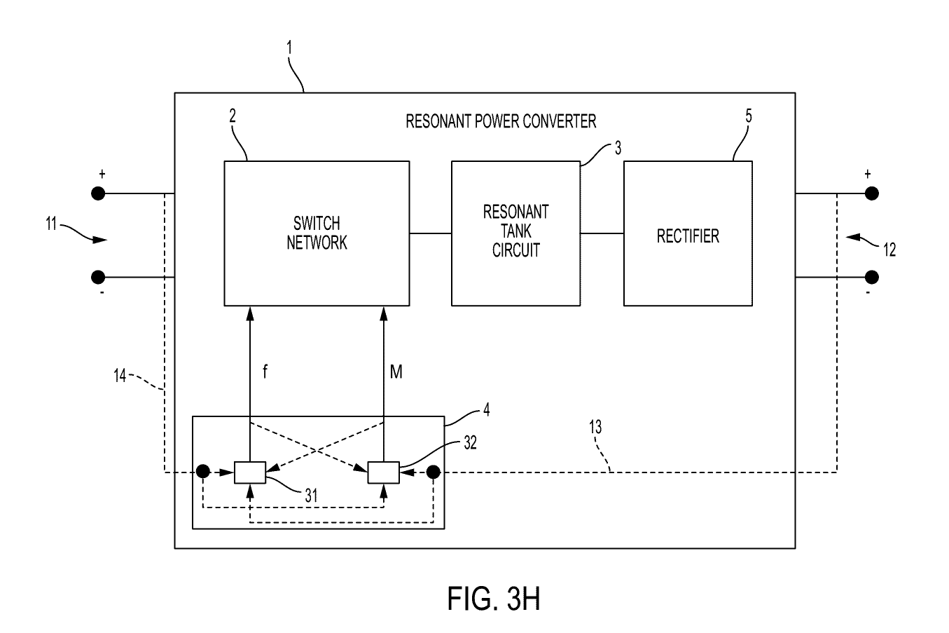

FIG. 3A shows a block diagram of a resonant power converter 1, according to some embodiments. Resonant power converter 1 includes a switch network 2 connected to a resonant tank circuit 3. The resonant power converter has an input port 11 and an output port 12, each with high-side and low-side terminals (+/−). In some embodiments, the resonant power converter 1 may be an AC/DC converter and may include a rectifier 5 to rectify the output of the resonant tank circuit 3. In some embodiments, the resonant power converter 1 may produce a DC output voltage at output port 12. Input port 11 may receive a rectified input signal from an AC line, which may be a voltage that varies across a wide range. In some embodiments, the resonant power converter 1 may have a switching frequency of greater than 100 kHz, such as 500 kHz or greater, 1 MHz or greater, 5 MHz or greater, or even higher. The switching frequency may be less than 300 MHz.

The resonant tank circuit 3 may include any suitable combination of at least one inductive element and at least one capacitive element. For example, the resonant tank circuit 3 may include an inductive element and a capacitive element in series (e.g., for a series resonant converter), an inductive element and a capacitive element in parallel (e.g., for a parallel resonant converter), two inductive elements and a capacitive element (e.g., for an LLC converter) or two capacitive elements and an inductive element (e.g., for a LCC converter), by way of example and not limitation.

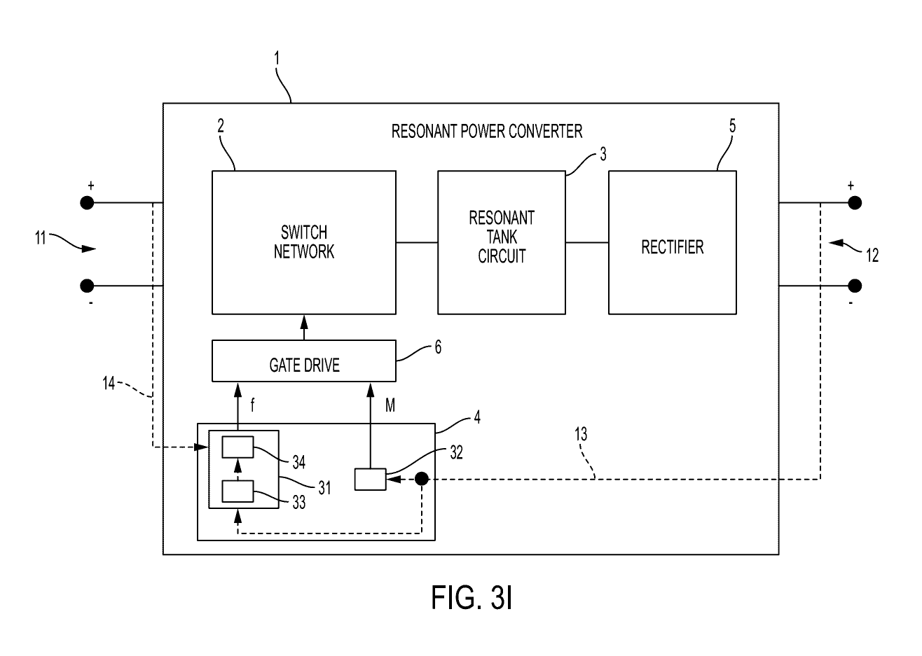

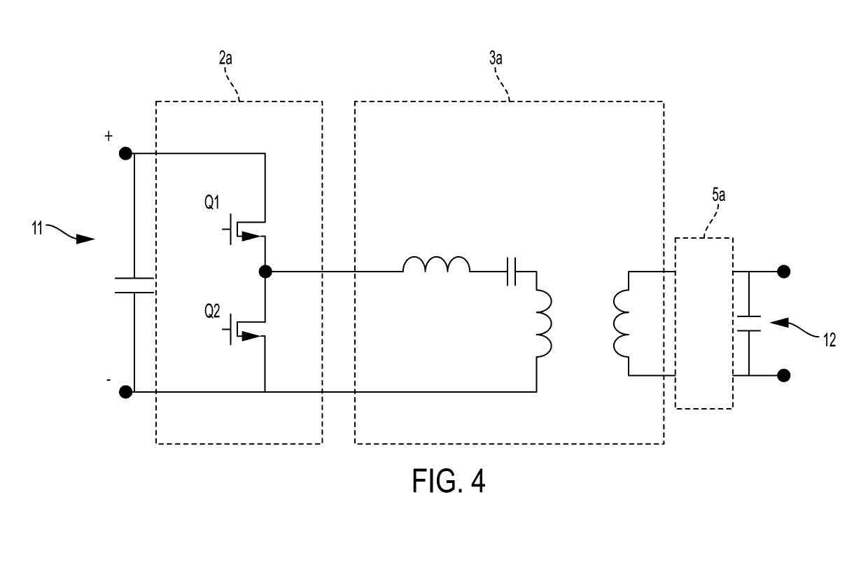

FIG. 4 shows an example of a switch network 2a, resonant tank circuit 3a and output rectifier 5a for an LLC converter. The switch network 2a includes switches Q1 and Q2 that connect the input of the resonant tank circuit 3a to different voltage terminals at different times during a switching period and allow the input of the resonant tank circuit 3a to float for a portion of a switching period. The switching frequency is the frequency at which switches Q1 and Q2 are switched when the resonant power converter is turned on. However, an LLC converter is shown merely by way of illustrating a resonant power converter, as the techniques described herein are not limited to LLC converters.

As shown in FIG. 3A, a controller 4 provides control signals to a gate drive circuit 6 to drive the switch network at a switching frequency f with a sub-modulation duty ratio M. To control the output and/or the input of the resonant power converter 1, the controller 4 controls the switching frequency f and sub-modulation duty ratio M. The controller 4 may control the switching frequency f and sub-modulation duty ratio M using feedback control, feedforward control, both feedback and feedforward control, or any other suitable type of control.

For feedback control, the output (e.g., voltage, current and/or power) of the resonant power converter may be measured and fed back to the controller 4 via a feedback path 13. The controller 4 may compare the output to a setpoint of voltage, current or power and modify the switching frequency f and/or modulation duty ratio M based on the difference between the output and the setpoint.

For feedforward control, the input (e.g., voltage, current and/or power) of the resonant power converter may be measured and fed forward to the controller 4 via a feedforward path 14. Controller 4 may then vary the switching frequency f and/or sub-modulation duty ratio M based on the input. There are a number of different ways in which f and M may be controlled based on feedback and/or feedforward control.

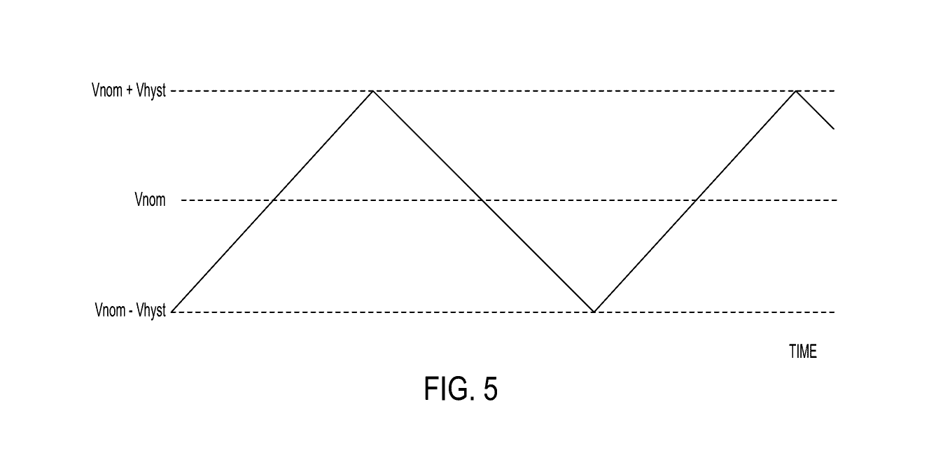

FIG. 3B shows an embodiment in which the sub-modulation duty ratio M is controlled to regulate the output of the resonant power converter 1 and the switching frequency f is controlled based upon the input. To control the output using sub-modulation duty ratio M, the output (voltage, current and/or power) is measured and fed back to the sub-modulation control portion 32 of controller 4 via feedback path 13. The sub-modulation control portion 32 may be a circuit or software module of controller 4, for example. The sub-modulation control portion 32 may compare the measured output with an output setpoint of voltage, current and/or power. For example, if the resonant power converter 1 is designed to produce an output voltage of 5V, the controller 4 may measure the output voltage and compare it to a setpoint of 5V. If the output voltage is too low, the sub-modulation control portion 32 may increase the sub-modulation duty ratio M. If the output voltage is too high, the sub-modulation control portion 32 may decrease the sub-modulation duty ratio M. Any suitable feedback control technique may be used to adjust M, such as proportional control, proportional-integral (PI) control, proportional-integral-derivative (PID) control, or any other suitable type of feedback control. The output may be controlled by modulation of the sub-modulation duty ratio M or by hysteretic control of the sub-modulation duty ratio M. Hysteretic control will be described with reference to FIG. 5.

FIG. 5 illustrates the output (e.g., the output voltage of the resonant power converter 1) when the output is controlled by hysteretic control. In hysteretic control, a hysteresis band may be defined that spans a nominal value (e.g., a nominal voltage Vnom). The sub-modulation control portion 32 switches between setting a high value of M (M_high) that causes the output to increase and a low value of M (M_low) that allows the output to decrease. M_high is less than or equal to 1 and greater than M_low. M_low is greater than or equal to 0 and less than M_high. When the output reaches the lower edge of the hysteresis band Vnom−Vhyst, the sub-modulation control portion 32 sets the value of M to M_high to increase the output. When the output reaches the upper edge of the hysteresis band Vnom+Vhyst, the sub-modulation control portion 32 sets the value of M to M_low to allow the output to decrease. As a result, the output may oscillate between the edges of the hysteresis band, as shown in FIG. 5.

In the embodiment of FIG. 3B, to control the switching frequency f, the input (voltage, current and/or power) may be measured and fed forward to the switching frequency control portion 31 of controller 4 via feedforward path 14. The switching frequency control portion 31 may be a circuit or software module of controller 4, for example. The switching frequency control portion 31 may store a map, such as table or function, that maps various inputs to a corresponding switching frequency. In the case of an LLC converter controlled on the inductive side of its transfer function, if the input decreases, the switching frequency control portion 31 may decrease the switching frequency f to compensate for the decreased input. Conversely, if the input increases, the switching frequency control portion 31 may increase the switching frequency f to compensate for the increased input. Any suitable feedforward technique may be used to control the switching frequency f.

Since the output is controlled by sub-modulation duty ratio M, and the switching frequency only varies in response to the input, the switching frequency f can stay within a narrower range than if switching frequency modulation were used to regulate the output as well as to accommodate varying input voltages.

In the embodiment of FIG. 3C, the control of M and f are flipped, such that switching frequency f is varied to control the output of the power converter, and the sub-modulation duty ratio M is controlled based on the input.

To control the output using switching frequency f, the output (voltage, current and/or power) is measured and fed back to the switching frequency control portion 31 of controller 4 via feedback path 13. The controller 4 may compare the measured output with an output setpoint of voltage, current and/or power. For example, if the resonant power converter 1 is designed to produce an output voltage of 5V, the controller 5 may measure the output voltage and compare it to a setpoint of 5V. In the case of an LLC converter operated on the inductive side of its transfer function, if the output voltage is too low, the switching frequency control portion 31 may decrease the switching frequency f. If the output voltage is too high, the switching frequency control portion 31 may increase the switching frequency f. Any suitable feedback control technique may be used to control f, such as proportional control, proportional-integral (PI) control, proportional-integral-derivative (PID) control, or any other suitable type of feedback control. The output may be controlled by modulation of the switching frequency f or by hysteretic control of the switching frequency f. In hysteretic control, the switching frequency control portion 31 switches between setting a low value of f (f_low) that causes the output to increase and a high value of f (f_high, which is higher than f_low) that allows the output to decrease. With reference to FIG. 5, when the output reaches the lower edge of the hysteresis band Vnom-Vhyst, the switching frequency control portion 31 sets the value of f to f_low to increase the output. When the output reaches the upper edge of the hysteresis band Vnom+Vhyst, the switching frequency control portion 31 sets the value of f to f_high to allow the output to decrease.

Above are described examples in which the control parameters f and M are controlled independently by feedforward and feedback control. However, in some embodiments, f, M or both f and M may be controlled by a combination of feedback and feedforward control, as illustrated in FIG. 3D. FIG. 3D shows that f, M, or both f and M may be controlled by feedback control, feedforward control, or both feedback and feedforward control. FIG. 3E shows that f, M, or both f and M may be controlled by feedback control without the use of feedforward control. FIG. 3F shows that f, M, or both f and M may be controlled by feedforward control without the use of feedback control.

As illustrated in FIG. 3G, in some embodiments the switching frequency f and sub-modulation duty ratio M may be controlled based on each other. The sub-modulation duty ratio may be fed back to the switching frequency control portion 31 to at least partially control switching frequency f. Alternatively or additionally, the switching frequency f may be fed back to the sub-modulation control portion 32 to at least partially control the sub-modulation duty ratio M. Controlling f and/or M based upon each other may be performed in addition to feedback or feedforward control from the output and/or input.

FIG. 3H illustrates that f and M may be controlled by any combination of feedback control from the output, feedforward control from the input, and/or feedback control of the other control parameter M or f. More specifically, f may be controlled based upon any one or more of the following: feedback control from the output, feedforward control from the input, and/or M. M may be controlled based upon any one or more of the following: feedback control from the output, feedforward control from the input, and/or f.

In some embodiments, the controller 4 may store a set of curves or values that maps the measured parameters (e.g., input and/or output parameters) to control parameters for the power converter, such as a switching frequency f and/or sub-modulation duty ratio M. Such curves and/or values may be selected by simulation, theory, or measurement to provide high efficiency at the respective operating parameters. As another example, an operating surface in multiple dimensions (e.g., f and M) may be approximated and the operating points calculated in real time based upon the measured parameters.

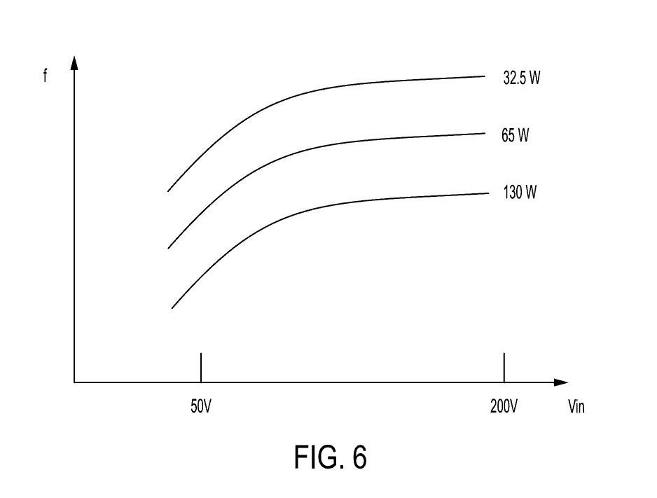

FIG. 3I shows an example in which switching frequency f is controlled using such a mapping. The switching frequency control portion 31 includes a curve selection portion 33 that selects a mapping of input voltage to switching frequency based upon the measured output power. The curve selection performed by curve selection portion 33 is illustrated in FIG. 6. The controller 4 may store a plurality of curves mapping input voltage to switching frequency. The curve selection portion 33 receives the output power measurement and selects the corresponding curve. For example, if the measured output power is 32.5 W, the top curve in FIG. 6 is selected. The selection is provided to the mapping portion 34 of switching frequency control portion 31. The mapping portion 34 receives the measured input voltage and maps the measured input voltage to a switching frequency f based on the selected curve. Controller 4 controls the gate drive circuit 6 based upon the determined switching frequency f.

The term “curve” is used to illustrate the mapping between input voltage and switching frequency. However, any suitable mapping may be used. The mappings may be defined during a design, characterization, and/or manufacturing stage of the resonant power converter and stored by the controller. The controller 4 may store a plurality of mappings for different output powers. Any suitable number of mappings may be stored. Alternatively, the controller 4 may store one or more functions that may be used by the controller 4 to calculate the mappings. In some embodiments, the controller may interpolate between respective mappings (e.g., curves or functions) for measured output powers that fall between the respective mappings. For example, if the controller 4 measures the output power as 50 W, and the controller 4 stores the three curves shown in FIG. 6, the controller 8 may interpolate between the curves corresponding to 32.5 W and 65 W to determine a mapping between them for 50 W.

Another way to determine the switching frequency is for the switching frequency control portion 31 to map both the output power and input voltage to a point on a 3D surface that defines the switching frequency as a function of output power and input voltage. The controller may store the 3D surface as a mapping from output power and input voltage to switching frequencies. The 3D surface may be stored in any suitable way, such as by storing points defining the 3D surface, or by storing a function defining the 3D surface, by way of example. In some embodiments, the controller may interpolate between points on the 3D surface to determine a switching frequency between available values.

Since the most efficient operating point may vary with the output and/or the input of the resonant power converter 1, and two degrees of freedom of control are available, in some embodiments, the sub-modulation duty ratio M and switching frequency f may be selected to control the output using the combination of sub-modulation duty ratio M and switching frequency f that results in the highest efficiency, or an efficiency above a suitable threshold.

In some embodiments, the switching frequency f may be fixed, e.g., at a value selected to maximize efficiency, and sub-modulation duty ratio may be used to control the resonant power converter. If the ability of sub-modulation duty ratio modulation to control the resonant power converter is exceeded, the switching frequency may then be varied as an additional control parameter at one or more extremes of the input and/or output range of the converter. Since very low values of M may produce inefficiencies, the controller 4 may set one or more thresholds, and when the sub-modulation duty ratio M reaches a minimum threshold level, the controller may switch over to frequency modulation as a control technique for the power converter. Such a technique may provide very high efficiency between the extremes of the converter's operating range of inputs and/or outputs.

VFX Converter

In some embodiments, the input of the resonant converter may be preceded by a VFX converter, as described in Inam, Wardah, David J. Perreault, and Khurram K. Afrdi. “Variable frequency multiplier technique for high efficiency conversion over a wide operating range.” Energy Conversion Congress and Exposition (ECCE), 2014 IEEE. IEEE, 2014, which is hereby incorporated by reference in its entirety. Use of a VFX converter on the input may enable increasing the input range. For example, a power converter, such as a power adapter, may use the VFX converter for a large input voltage, such as line voltage in Europe (e.g., 240 V), and turn off the VFX converter for lower input voltages, such as U.S. line voltages (e.g., 120 V).

Soft-Start

Some of the techniques described herein relate to soft-starting a resonant power converter, such as an LLC converter. The inventors have appreciated that soft-starting a resonant power converter can be useful in certain circumstances. For example, when a power adapter is plugged into a receptacle, the AC line voltage suddenly appears across the input. When it is first turned on, an LLC converter may attempt to deliver significant power at the output to charge its output capacitor. If a VFX converter is connected to the input, plugging in the power adapter to connect it to the line can cause the midpoint between the input capacitors of the VFX converter to shift from ½ of the input voltage. If the transistors of the LLC converter have a breakdown voltage lower than the peak line voltage, the voltage across them may exceed their breakdown voltage, which can cause them to fail.

In some embodiments, when the power converter is started up (e.g., upon being connected to the line), the switching frequency may be started at a high value (e.g., the maximum switching frequency) and then gradually decreased until the converter reaches a suitable operating range for delivering power to a load. For example, the switching frequency may be gradually decreased until the output of the power converter reaches a setpoint. Such a soft-start technique may enable limiting the power that is initially processed though the converter to allow voltages to settle and avoid damage to the switches of the converter.

Control of Duty Ratio and Sub-Modulation Duty Ratio

Embodiments are described above in which a power converter is controlled by varying two control parameters: sub-modulation duty ratio M and switching frequency f. In some embodiments, a power converter may be controlled using a combination of sub-modulation duty ratio and another control parameter. For example, some power converters may be controlled by varying the sub-modulation duty ratio M and the duty ratio D.

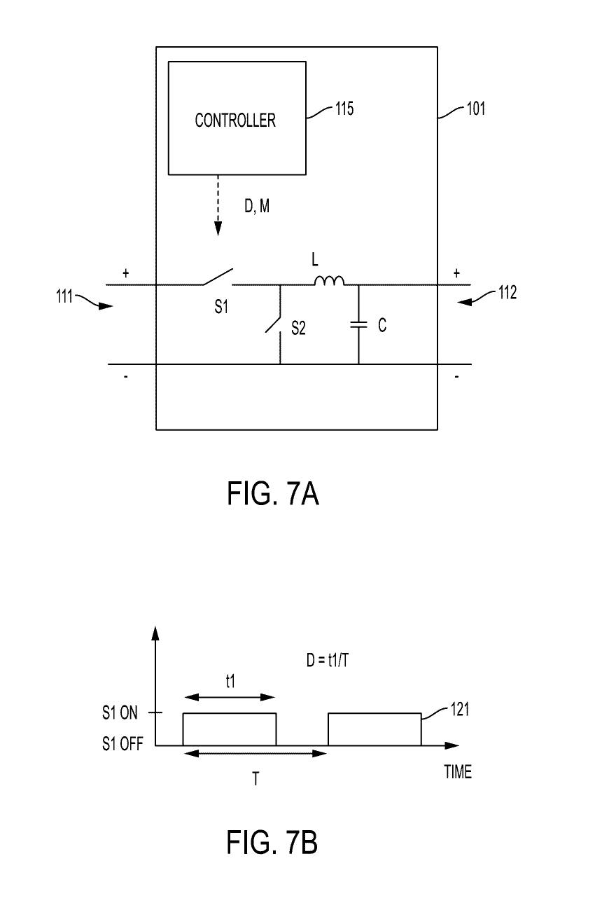

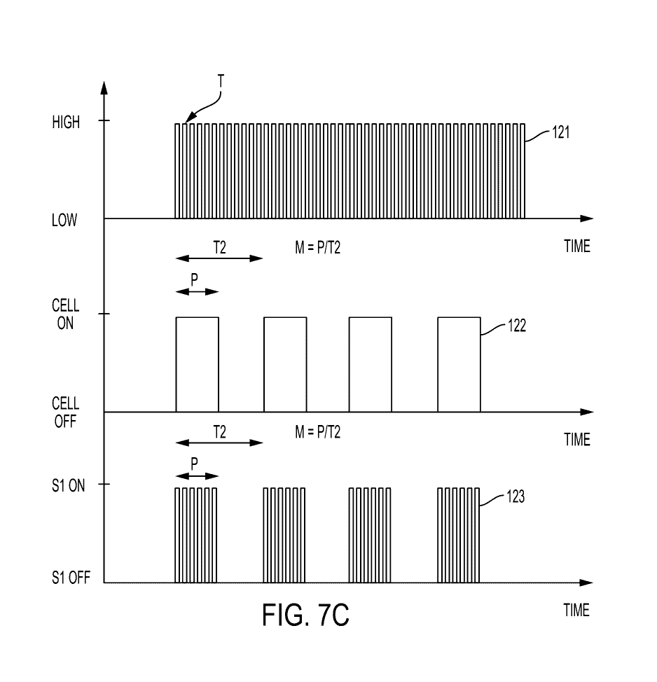

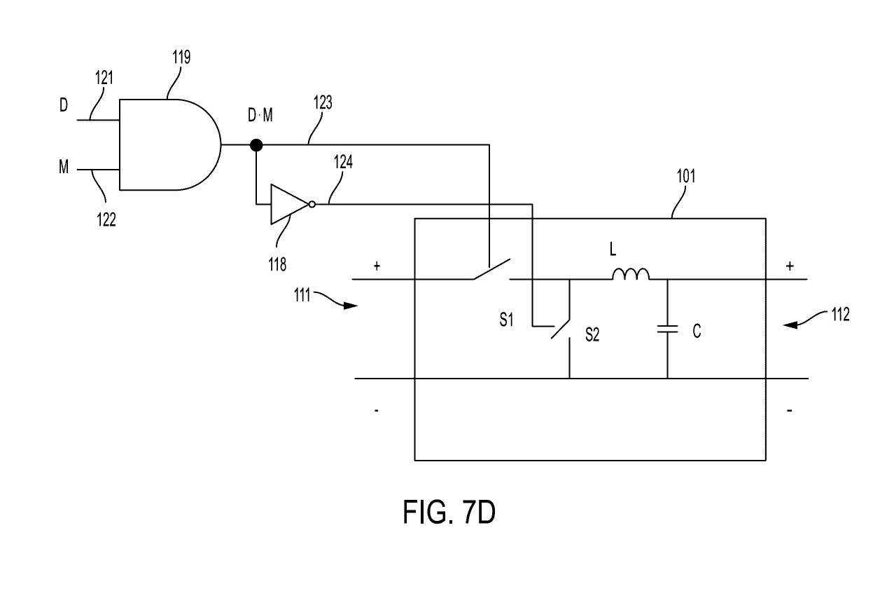

FIG. 7A shows a buck converter as an example of a power converter 101. The buck converter includes a high-side switch S1 and a low-side switch S2. The buck converter switches between turning switch S1 on (with switch S2 off) and turning switch S2 on (with switch S1 off). The fraction of a switching period for which S1 is turned on is the duty ratio D of the power converter 101. The switching of the switches S1 and S2 at a duty ratio D is controlled by a controller 115. Controller 115 may use any suitable control technique to control the power converter 101, such as feedback or feedforward control, for example. Pulse width modulation (PWM) is one suitable control technique, though PWM is only one example of a technique for controlling a power converter based on duty ratio. Regardless of the technique used for controlling the power converter 101, in continuous conduction mode the output voltage (across the output 112) of the buck converter is proportional to the time average of the duty ratio D, which is controlled by controller 115. Switches S1 and S2 produce a square wave voltage that is filtered by the passive elements including inductor L and capacitor C to produce an output voltage proportional to the time average of the duty ratio D. FIG. 7B shows a switching period T in which the switch S1 is turned on by switching control signal 121 for a duration of t1. The duty ratio D is the fraction of the switching period for which S1 is turned on, and is equal to t1/T.

FIG. 7C illustrates sub-modulation of the power converter 101. In FIG. 7C, the entire power converter 101 is turned on and off, or “sub-modulated” at a frequency lower than the switching frequency of the power converter 101. FIG. 7C shows switching control signal 121 on a longer timescale than in FIG. 7B. FIG. 7C also shows a sub-modulation control signal 122 that turns the power converter 101 on and off with a sub-modulation period T2. The power converter 101 is turned on for a period P during the period T2. The fraction of time for which the power converter 101 is turned on termed the “sub-modulation duty ratio,” denoted M, which is equal to P/T2. The output of the power converter 101 can be controlled by controlling the sub-modulation duty ratio M. Increasing the sub-modulation duty ratio M increases the output voltage of the buck converter. Conversely, decreasing the sub-modulation duty ratio M decreases the output voltage of the buck converter. In some embodiments, the duty ratio D of the power converter may be held constant while the sub-modulation duty ratio is changed. In some embodiments, control of both the duty ratio D and the sub-modulation duty ratio M may be performed. In some embodiments, both the duty ratio D and the sub-modulation duty ratio M may be controlled to vary, which can provide two degrees of freedom for control of the power converter 101.

FIG. 7D illustrates circuitry for controlling the switches S1 and S2 based on the duty ratio D and the sub-modulation duty ratio M. The AND gate 119 receives switching signal 121 having a duty ratio D and sub-modulation control signal 122 having a duty ratio M. The AND gate 119 multiplies these signals to produce an output 123 equal to D·M that is high when both D and M are high, and low otherwise. Signal 123 is provided to the control terminal of switch S1 to control switch S1. Switch S2 may be controlled by signal 124 that is complementary to signal 123. An inverter 118 can produce signal 124 based on signal 123. Suitable delay(s) can be introduced to prevent shoot-through (caused by switches S1 and S2 being turned on at the same time). Signal 124 is provided to the control terminal of switch S2 to control switch S2. Control based on M may be disabled by setting M equal to one. However, the circuit of FIG. 7D is provided merely by way of illustration, as it should be appreciated that the control signals for the switches S1 and S2 may be controlled digitally without the use of an AND gate or other logic. In some embodiments, the control signals may be generated by controller 115.

Switched Capacitor Circuit

AC line voltages vary from country to country, and range from 100 V RMS to 240 V RMS. A power adapter or power module that is capable of converting power from the AC line in different countries needs to be able to handle the variations in input voltage from country to country. As discussed above, providing the control capability to accommodate different input voltages may cause a power converter to operate less efficiently when switching frequency is slewed from an efficient operating point or operating range in order to accommodate the variation in input voltage.

To facilitate operating a power adapter or power module in different countries, an additional power converter may be introduced that can adjust for the variation in input voltages. In some embodiments, a resonant power converter may be preceded or followed by a switched capacitor converter that can accommodate different line voltages. Such a switched capacitor converter may operate in different modes (or may be deactivated) depending on the line voltage. For example, in some embodiments the switched capacitor converter may be a 2:1 voltage step-down converter. In a country with a relatively low high AC line voltage, such European countries that have an AC line voltage of 220V RMS, the switched capacitor converter can be controlled to step-down the input line voltage by a factor of 2:1. In a country with a relatively low AC line voltage, such as the U.S. (120 V RMS) or Japan (100 V RMS), the switched capacitor converter may be turned off or set to a mode that does not step down the voltage. As a result, the resonant power converter sees an input voltage in a relatively narrow range, and can be designed to operate efficiently over this range. The switched capacitor converter can accommodate different AC line voltages and avoids the need for the resonant power converter to slew switching frequency from an efficient operating point or range in order to accommodate the different AC line voltages in different countries. Since a switched capacitor converter can be operated with very high efficiency, the overall efficiency of the power adapter or power module remains high.

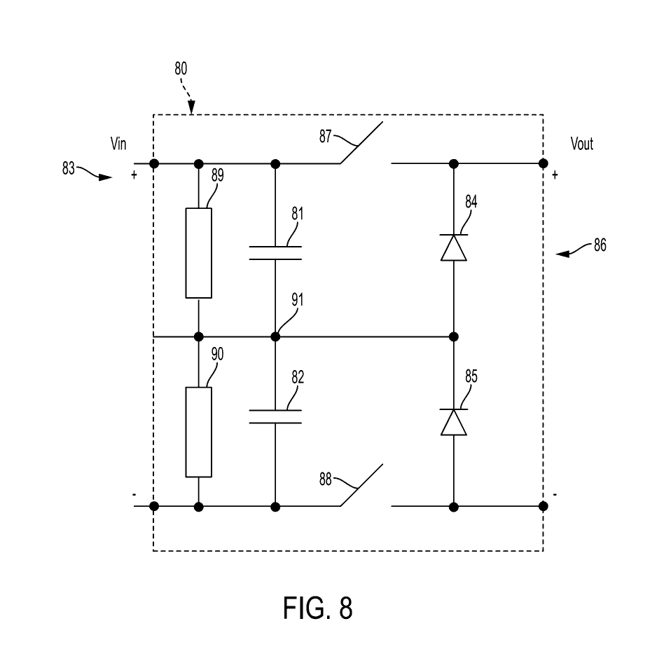

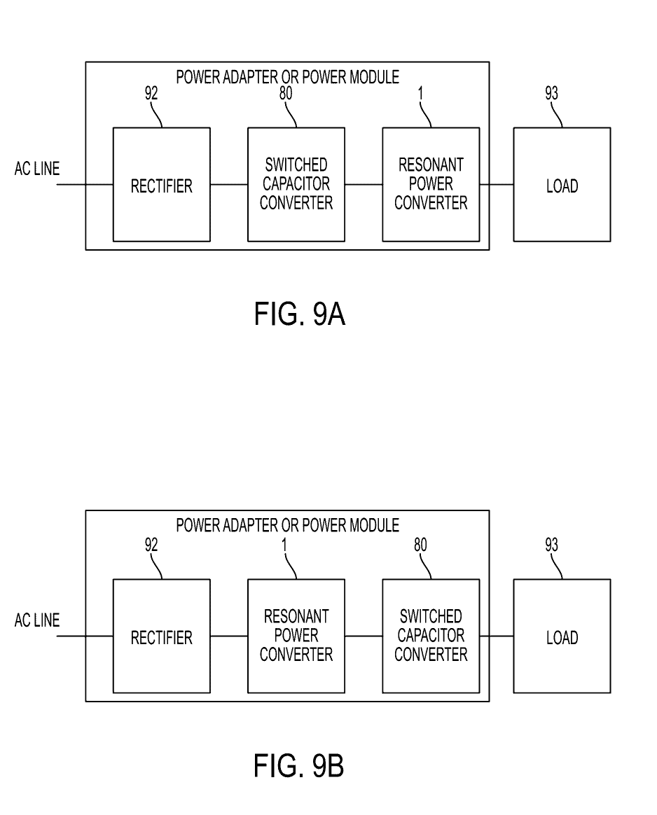

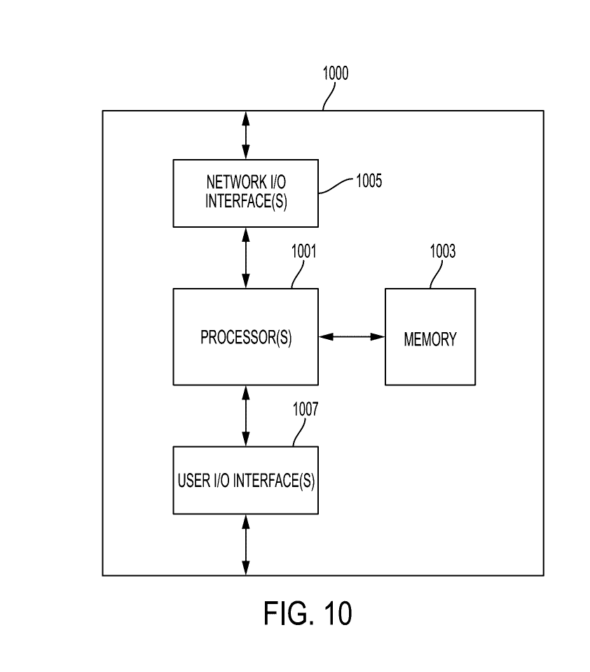

FIG. 8 shows an example of a switched capacitor converter 80, according to some embodiments. Switched capacitor converter 80 has capacitors 81 and 82 connected in series across the input port 83 of the switched capacitor converter 80. Capacitors 81 and 82 may have the same capacitance values. Capacitors 81 and 82 form a capacitive voltage divider that divides the voltage (Vin) of the input port 83 by half at their connection point 91, which has a voltage of Vx=Vin/2. Diodes 84 and 85 are connected in series across the output port 86 of the switched capacitor converter 80, and are connected at connection point 91. Switch 87 is connected between the high-side input and the high-side output of the switched capacitor converter 80. Switch 88 is connected between the low-side input and the low-side output of the switched capacitor converter 80.

In operation, switches 87 and 88 alternate turning on (conductive) and off (non-conductive) at a suitable switching frequency (e.g., in the kHz or MHz range). Switches 87 and 88 alternate turning on and off, such that when switch 87 is on switch 88 is off, and when switch 88 is on switch 87 is off. The switching of switches 87 and 88 alternately connects capacitors 81 and 82 in parallel with the output port 86. Since both capacitor 81 and capacitor 82 carry a voltage of Vin/2, the output port 86 is held at a voltage of Vin/2.

When switch 87 is on and switch 88 is off, capacitor 81 is connected in parallel with the output 86. Diode 85 is forward-biased and diode 84 is reverse-biased. A current path is provided through diode 85, capacitor 81, switch 87 and the output port 86.

When switch 88 is on and switch 87 is off, capacitor 82 is connected in parallel with the output port 86. Diode 84 is forward-biased and diode 85 is reverse-biased. A current path is provided through capacitor 82, diode 84, the output port 86 and switch 88.

The switching of the switched capacitor converter 80 may be controlled by a controller, which may be controller 4 of the resonant power converter, a controller of the switched capacitor converter 80, or another controller. The controller may detect the AC line voltage and control the switched capacitor converter 80 based on the detected AC line voltage. If a high AC line voltage is detected (e.g., over 200 V), the controller activates the switched capacitor converter 80 to operate as a 2:1 step-down converter by switching the switches of the switched capacitor converter. If a low AC line voltage is detected (e.g., below 150 V), the controller deactivates the switched capacitor converter 80 and allows the received voltage to pass through the switched capacitor converter 80 without stepping down to voltage. To deactivate the switched capacitor converter 80, both switches 87 and 88 can be turned on, which results in Vout being equal to Vin.

Optionally, resistive elements 89 and 90 may be connected across the input port 83, and connected at connection point 91. Resistive elements 89 and 90 may provide a current path to charge connection point 91 to Vin/2. Resistive elements 89 and 90 may have the same resistance values. To reduce power dissipation, resistive elements 89 and 90 may have high resistance values (e.g., a megaohm or greater). Resistive elements 89 and 90 may be formed by resistors or other devices with suitable resistance values, such as transistors, for example.

Diodes 84 and 85 represent an example of a switching element, and may be replaced by another switching element. For example, diodes 84 and 85 may be replaced by transistors. A transistor replacing diode 84 may be turned off when switch 87 is turned on, and turned on when switch 87 is turned off, as with diode 84. Similarly, a transistor replacing diode 85 may be turned on when switch 87 is turned on, and turned off, when switch 87 is turned off.

FIG. 6 shows a power adapter or power module in which a resonant power converter 1 is preceded by a VFX converter 80. Depending on the input voltage, the VFX converter 80 may step down the voltage by a factor of 2:1 or may not step down the voltage, as discussed above. The resonant power converter may then convert the received voltage to a suitable value for driving the load 93.

In the power converters described herein, it should be appreciated that input and/or output filters may be included. The input or output filters may take the form of a capacitor in parallel with the input or output, by way of example.

Controller(s) and Computing Devices

The controllers described herein may be implemented by circuitry such as electronic circuits or a programmed processor (i.e., a computing device), such as a microprocessor, or any combination thereof.

FIG. 7 is a block diagram of an illustrative computing device 1000 that may be used to implement any of the above-described techniques. Computing device 1000 may include one or more processors 1001 and one or more tangible, non-transitory computer-readable storage media (e.g., memory 1003). Memory 1003 may store, in a tangible non-transitory computer-recordable medium, computer program instructions that, when executed, implement any of the above-described functionality. Processor(s) 1001 may be coupled to memory 1003 and may execute such computer program instructions to cause the functionality to be realized and performed.

Computing device 1000 may also include a network input/output (I/O) interface 1005 via which the computing device may communicate with other computing devices (e.g., over a network), and may also include one or more user I/O interfaces 1007, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A power module, comprising:
a resonant power converter including:
a switch network having one or more switches; and
a resonant tank circuit; and
a controller configured to control the resonant power converter, the controller being configured to switch the one or more switches of the switch network at a switching frequency, the controller being configured to sub-modulate the resonant power converter on and off at a second frequency lower than the switching frequency with a sub-modulation duty ratio, the controller being configured to control the resonant power converter by varying the switching frequency and the sub-modulation duty ratio.

2. The power module of claim 1, wherein the controller is configured to control the resonant power converter based on an input to the resonant power converter.

3. The power module of claim 2, wherein the controller is configured to vary the switching frequency based on the input to the resonant power converter.

4. The power module of claim 1, wherein the controller is configured to control the resonant power converter based on an output of the resonant power converter.

5. The power module of claim 4, wherein the controller is configured to vary the sub-modulation duty ratio based on the output of the resonant power converter.

6. The power module of claim 5, wherein the controller is configured to vary the sub-modulation duty ratio using hysteresis.

7. The power module of claim 5, wherein the controller is configured to vary the switching frequency based on an input to the resonant power converter.

8. The power module of claim 1, wherein the controller is configured to vary the switching frequency based on an input and/or output of the resonant power converter, and the controller is configured to vary the sub-modulation duty ratio based on an input and/or output of the resonant power converter.

9. The power module of claim 8, wherein the controller is configured to vary the switching frequency based on the input to the resonant power converter and the output of the resonant power converter.

10. The power module of claim 8, wherein the controller is configured to vary the sub-modulation duty ratio based on the input to the resonant power converter and the output of the resonant power converter.

11. The power module of claim 1, wherein the controller is configured to vary the switching frequency based on the sub-modulation duty ratio.

12. The power module of claim 1, wherein the controller is configured to vary the sub-modulation duty ratio based on the switching frequency.

13. The power module of claim 1, wherein the power module is configured to receive an AC line voltage.

14. The power module of claim 13, wherein the power module does not have a power factor correction circuit.

15. The power module of claim 13, wherein the power module is configured to receive an AC line voltage with a magnitude of between 100 V and 240 V RMS.

16. The power module of claim 1, wherein the power module is a power adapter.

17. The power module of claim 1, wherein the resonant power converter comprises an LLC converter or a phi-2 converter.

18. The power module of claim 1, wherein the switching frequency is at least 500 kHz and below 300 MHz and the second frequency is at least 20 kHz.

19. A controller for a resonant power converter including a switch network having one or more switches and a resonant tank circuit, the controller comprising:
circuitry configured to control the resonant power converter to switch the one or more switches of the switch network at a switching frequency, to sub-modulate the resonant power converter on and off with a sub-modulation duty ratio at a second frequency lower than the switching frequency, and to control the resonant power converter by varying the switching frequency and the sub-modulation duty ratio

20. A method of controlling a resonant power converter including a switch network having one or more switches and a resonant tank circuit, the method comprising:
switching the one or more switches of the switch network at a switching frequency;
sub-modulating the resonant power converter on and off with a sub-modulation duty ratio at a second frequency lower than the first frequency; and
varying the switching frequency and the sub-modulation duty ratio of the resonant power converter.

21. A power module, comprising:
a power converter having one or more switches; and
a controller configured to control the power converter, the controller being configured to switch the one or more switches at a switching frequency, the controller being configured to sub-modulate the power converter on and off with a sub-modulation duty ratio at a second frequency lower than the switching frequency, the controller being configured to control the power converter by varying the sub-modulation duty ratio as a first control parameter and by varying a second control parameter of the power converter.

22. The power module of claim 21, wherein the second control parameter comprises a second duty ratio.

23. A controller for a power converter, the power converter having one or more switches, the controller comprising:
circuitry configured to switch the one or more switches at a switching frequency, to sub-modulate the power converter on and off with a sub-modulation duty ratio at a second frequency lower than the switching frequency, and to control the power converter by varying the modulation duty ratio as a first control parameter and by varying a second control parameter of the power converter.

24. The controller of claim 23, wherein the second control parameter is duty ratio D.

25. A method of controlling a power converter having one or more switches, the method comprising:
switching the one or more switches at a first frequency;
sub-modulating the power converter on and off with a sub-modulation duty ratio at a second frequency lower than the switching frequency; and
controlling the power converter by varying the sub-modulation duty ratio as a first control parameter and by varying a second control parameter of the power converter.
